(19) United States
(12) Patent Application Publication
(10) Pub. No.: US 2009/0167685 A1
(43) Pub. Date: Jul. 2, 2009

(54) METHOD AND SYSTEM FOR PROVIDING A COMPUTER ENVIRONMENT FOR CHILDREN

(75) Inventors: Nicole Wrubel, Berkeley, CA (US); Monica Brown, Berkeley, CA (US); Maureen Bunney, Mill Valley, CA (US); Craig Hendrickson, Albany, CA (US)

Correspondence Address: MURABITO, HAO & BARNES, LLP, TWO NORTH MARKET STREET, THIRD FLOOR, SAN JOSE, CA, 95113, US

(73) Assignee: LeapFrog Enterprises, Inc., Emeryville, CA (US)

(21) Appl. No.: 12/209,557

(22) Filed: Sep. 12, 2008

Related U.S. Application Data
(60) Provisional application No. 60/998,671, filed on Oct. 11, 2007.

(51) Int. Cl. G06F 3/033; G06F 3/048

(52) U.S. Cl. 345/163; 715/706

(57) ABSTRACT

A computer system for providing a simulated computer environment for young children. A console is coupled to a display, e.g., a television set, for storing and processing a plurality of user selectable programs. User selectable program may be stored on a cartridge and received by the console. The user selectable programs are child oriented, educational, interactive and provide feedback responsive to user interaction. A theme-able wireless keyboard adapted for use by young children with keys larger in size than an adult keyboard is coupled with the console, e.g., infrared. The keyboard excludes a subset of adult oriented function and punctuation keys. A theme-able mouse and a mouse pad that is detachably couple to either the left or the right side of the keyboard may be included. An animated character in a GUI and in the programs interacts, gives user instruction and is the focus of reward in reward oriented programs.

### RELATED ART

This Application claims the benefit and incorporates by reference in its entirely the provisional application Ser. No. 60/998,671 with attorney docket No. LEAP-P0377.PRO, inventors Wrubel et al., entitled “A METHOD AND SYSTEM FOR PROVIDING A COMPUTER ENVIRONMENT FOR CHILDREN” that was filed on Oct. 11, 2007.

### TECHNICAL FIELD

The embodiments of the present invention relate to the field of computer systems. More particularly, embodiments of the present invention relate to a method and system for providing a computer environment for use with children.

### BACKGROUND ART

Computer usage has increased substantially in recent years. In fact, computers have become an integral part of every household. As a result, young children get exposed to many different types of computer systems at a very young age.

In general, young children tend to imitate their parents, older siblings and follow in their footsteps. Accordingly, young children become curious and interested about using computers because growing up they see their parents and older siblings use computers at home.

Unfortunately, most computer systems and equipment are not well suited for young children. For example, younger children can hardly operate adult keyboards because keys on adult keyboards are relatively small in size, contain complex keys and functionality and generally require more coordination than young children, e.g., a three year old, can handle. Moreover, computers and keyboards are very function oriented with various functionalities that increase their complexity, especially for young children, thereby making them unsuitable for young children.

In general, keyboards are not designed for use by young children. For example, young children tend to pound on keyboards instead of gently pressing the keys. Therefore, allowing children to use adult computers and adult keyboards does not enhance the child's learning experience and can also substantially reduce the lifespan of the devices.

Furthermore, exposure of young children to computers has led to an increase in risk of data loss and potential exposure to predators and other security risks. For example, allowing young children to use adult computers increases the risk of children inadvertently deleting important adult information or sharing private information with strangers, e.g., a file containing bank accounts. Moreover, allowing children to use adult computers may increase the risk of their exposure to strangers online.

The widespread development and supply software developed for children to run on adult computers has not solved the problems discussed above. Computers are relatively expensive and having only one computer in a household may create a conflict between young children wanting to use the computer for fun and learning and the parents' need to use the computer themselves. For example, parents often pay their bills online, answer their emails, etc. and young children often naturally want to use the computer when their parents are using the computer, thereby creating a conflict.

### SUMMARY

Accordingly, a need has arisen for a method and system to provide a computer environment that is suitable and designed specifically for children and that simulates a PC experience for the child. Furthermore, it is desired that above mentioned needs be accomplished in a cost effective manner. It will become apparent to those skilled in the art after reading the detailed description of the present invention that the embodiments of the present invention satisfy the above mentioned needs.

In one embodiment of the present invention, a computer system specifically for young children is designed. Accordingly to one embodiment, the computer system comprises a console and a keyboard. The console comprises a processing unit and a memory component. The memory component may store instructions for execution on the processing unit. The console may store a plurality of user selectable programs. Additionally, the console may have electronics to receive a memory or functionality cartridge containing one or more user selectable programs. The programs on the console may be animated that are suitable and interesting to young children. In general, the programs are educational in nature and reward based. The console may be coupled to a display, e.g., a television set, for displaying program data and audio and allowing young children to interact with displays and animated characters of the program. In one embodiment, standard television input connections are used to drive the signals to the television.

In one embodiment, the computer system's keyboard is wirelessly coupled to the console. According to one embodiment, keys on the keyboard are larger in size in comparison to keys on an adult keyboard, thereby more suitable for children and more durable. Furthermore, keys on the keyboard may be more widely spaced to be more suitable for children. Moreover, the keyboard has a reduced set of keys with functionality more suited for children and specifically it contains less punctuation keys. The keyboard may also contain non-functional or “fun keys.” The keyboard may further comprise a detachable mouse pad and a mouse for enabling user input information and interact with the computer, e.g., making a selection. The mouse and mouse pad may be detachable and be coupled to the left or the right side of the keyboard to facilitate left handed children as well as right handed children. It is appreciated that in one embodiment the mouse may be smaller in size in order to be more suitable for young children and fit in their hand. It is also appreciated that in one embodiment the mouse may have one button instead of two, which is adapted for easy use by children.

In addition, the keyboard and mouse and mouse pad may take on an appearance or theme, e.g., of an animal, that is fun and interesting for a child. In this case, in one expel, these components may be shaped like or contain images and/or colors of a dog, for instance. The keyboard may contain eyes, ears, a nose and mouth, for instance, while the mouse pad may resemble a paw.

The programs on the console are selected from a main display with each represented as a large icon. An animated character helps the child to select programs and informs them of what each program does when selected by a cursor. The animated character, the icons and the main display all conform to the theme of the keyboard and mouse pad. As a result, an inexpensive computer that is suitable for use by young children and that simulates a PC experience is provided.

More specifically, an embodiment of the present invention pertains to a computer system that includes a console operable to be coupled to a display. The console may include a processor operable to execute instructions; and a memory component operable to store data and computer executable code, wherein the code is operable to provide a plurality of user selectable programs, and wherein the plurality of user selectable programs are user interactive and educational, and wherein the plurality of user selectable programs provide feedback in response to the user.

The computer system may further include a wireless keyboard wirelessly coupled to the console, wherein the wireless keyboard is adapted for use by young children and operable to provide user interaction, and wherein the wireless keyboard comprises keys that are larger in size than an adult keyboard, and wherein the wireless keyboard may exclude adult oriented function and punctuation keys. In one embodiment, the computer system may include a mouse input device operable to facilitate a user selection tool and operable to aid in program navigation.

In one embodiment, the display may be a television set or any monitor suitable for home use. In one exemplary embodiment, the wireless keyboard is wirelessly coupled to the console via infrared signal. The mouse pad may be detachably coupled to either the left or the right side of the wireless keyboard. The keyboard unit and the console may be battery operated.

Since the computer system is designed for children, the mouse pad and/or the keyboard may be theme-able. In one embodiment, the plurality of user selectable programs provide an animated character of the theme, and wherein at least one of the plurality of user selectable programs is reward-task oriented for tasks completed by a young child, wherein the reward-task oriented program may provide something of value to the animated character for a correctly completed task. In one embodiment, the console is operable to receive a cartridge, and wherein the cartridge contains a plurality of instructions for executing a task to interactively facilitate educational instructions to a user and in response thereto provide feedback.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a diagram of an exemplary computer system in accordance with one embodiment of the present invention.

FIG. 2A shows an exemplary wireless keyboard in accordance with one embodiment of the present invention.

FIG. 2B illustrates one example keyboard and mouse and mouse pad in accordance with one embodiment of the present invention.

FIGS. 3A and 3B show an exemplary graphical user interface in accordance with one embodiment of the present invention.

FIG. 4 shows a GUI executing a selectable program in accordance with one embodiment of the present invention.

FIG. 5 shows an exemplary flow diagram for providing a computer environment to young children in accordance with one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “creating” or “transferring” or “executing” or “displaying” or “initiating” or “interacting” or “determining” or “instructing” or “issuing” or “accessing” or “obtaining” or “selecting” or “calculating” or “measuring” or “querying” or “receiving” or “sending” or “providing” or “storing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### A Method and System for Providing a Computer Environment for Children

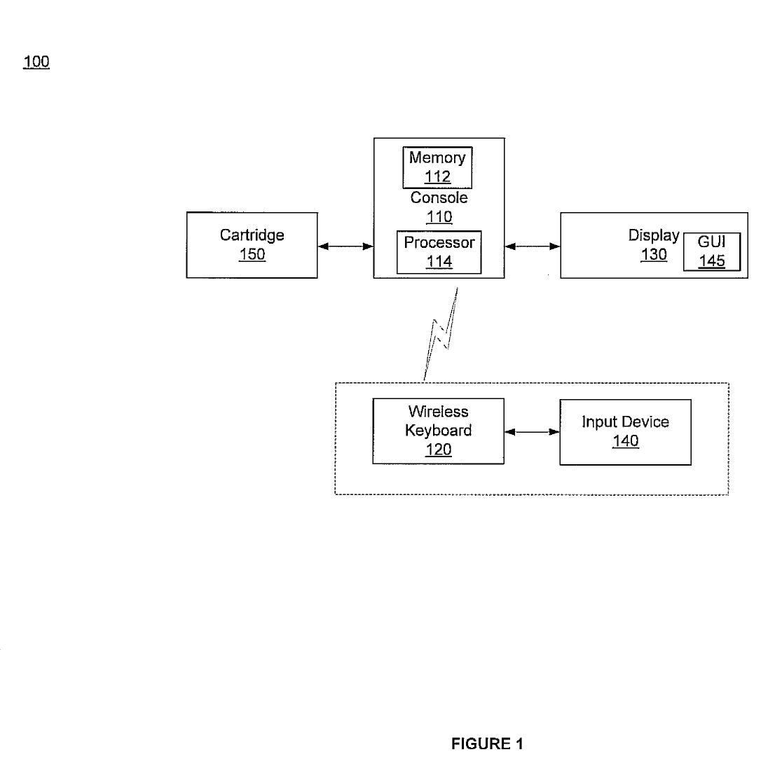

Referring now to FIG. 1, an exemplary computer system 100 in accordance with one embodiment of the present invention is shown. The computer system 100 comprises a console unit 110 and a wireless keyboard 120. Optionally the computer system 100 may further include a removable cartridge 150 and an input device 140. The console unit 110 of the computer system 100 may be located near and coupled to a display 130 for displaying information and graphical user interface. The console 110 may be located on or near a television set, for instance, and connected to drive images for display on the television.

According to one embodiment, the console 110 includes a memory component 112 and a processing unit 114. The memory component 112 is operable to store executable instructions and other data. In one exemplary embodiment, the memory component 112 stores a plurality of user selectable programs that may be processed by the processing unit 114. Additional programs may be added via the removable cartridge 150.

The plurality of user selectable programs may include entertaining and educational programs suitable for young children, e.g., a counting game, a spelling game, a coloring game, a simulated email program, etc. Any number of various programs can be included. It is appreciated that in one embodiment a graphical user interface (GUI) 145 used to select programs may be animated and have animated characters, e.g., a dog, for assisting the child. It is further appreciated that in one embodiment one or more of the plurality of user selectable programs may be animated and may have animated characters that may be the same character as the animated character as provided by in the GUI 145. In one exemplary embodiment, at least one of the plurality of user selectable programs may be a reward based program where children are rewarded for successfully completing a task. The reward may also be associated with the animated character.

The animated character of the GUI 145 and/or of the programs may be interactive. For example, the animated character may ask the young child to perform a task, e.g., press the letter “A”. In one embodiment, the animated character may bark and/or make other sounds. If the child fails to correctly complete the task, the animated character may provide the child with hints and feedback to complete the task. Once the task has been successfully completed, the animated character may be rewarded. It is further appreciated that the animated character may be the same character for all or a portion of the plurality of user selectable programs.

In one embodiment of the present invention, the console 110 is coupled to the display 130 to display the GUI 145, the plurality of user selectable programs, games, instructions, animated characters, etc. The display in one embodiment may be a television set or any monitor suitable for home use. The console 110 may be coupled to the display 130 via a standard RCA output for instance or any well known composite or digital input found on most televisions. The display 130 enables children to see and hear the GUI 145 and the programs and use the keyboard 120 and/or the input device 140 to interact with the GUI 145 and the user selectable programs. It is appreciated that the display 130 may include an audio output, e.g., speakers, for outputting feedback, instructions, music, etc. The display 130 may display the plurality of user selectable programs as large icons on the GUI 145 on the display 130. It is appreciated that the console 110 may be coupled to a set-top-box or directly to the television.

The console 110 may also be coupled to the removable cartridge 150 for adding memory and programs. In one example, the removable cartridge 150 may contain at least one user selectable and/or reward based programs for young children. For example, the removable cartridge 150 may include a coloring game that teaches children about different colors.

The console 110 may be battery operated or may receive power from a line connected and may be wirelessly coupled to the wireless keyboard 120. Various methods for wirelessly coupling may be employed. In this exemplary embodiment, infrared is used to wirelessly couple the keyboard 120 to the console 110. The wireless keyboard 120 may be used as a means to enable children to interact with the GUI 145 and with one or more of the plurality of user selectable programs. For example, the keyboard 120 may be used to perform a task as indicated by the program, e.g., pressing the letter “A”. According to one embodiment of the present invention, the keyboard 120 may be further coupled to other input devices 140. For example, the input device 140 may be a mouse and a mouse pad, a joystick, etc. It is appreciated that the input device 140 may be separately coupled to the console 110 via a wireless and/or wired connection. In this exemplary embodiment, the input device 140 is coupled to the console 110 via the wireless keyboard 120. The keyboard 120 may be battery operated. The keyboard 120 may also be connected to the console 110, in one embodiment, via a wired connection.

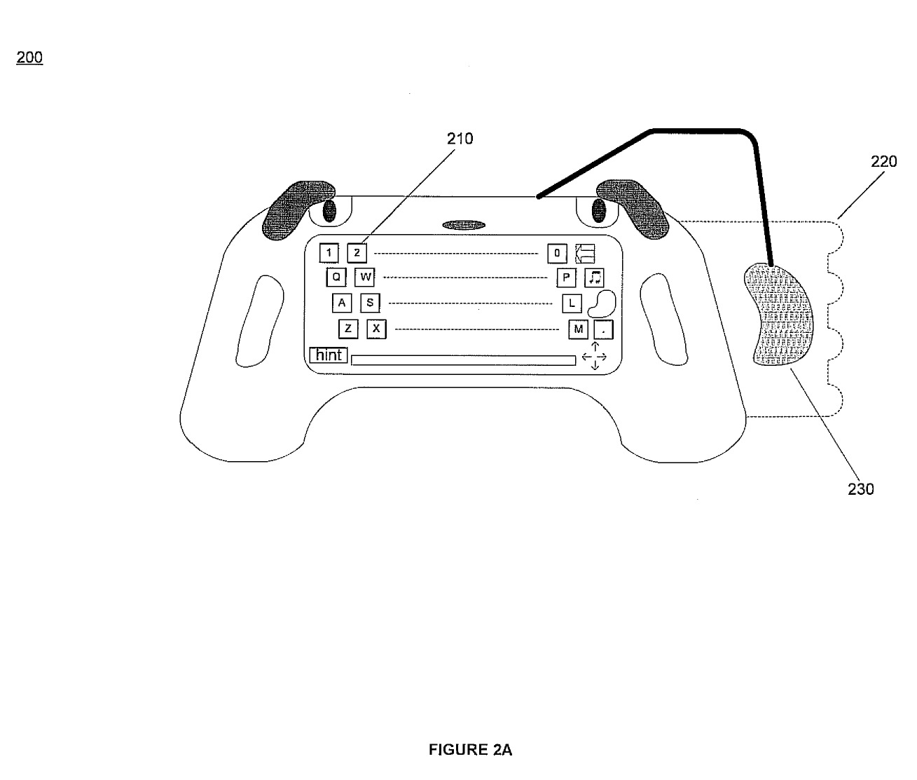

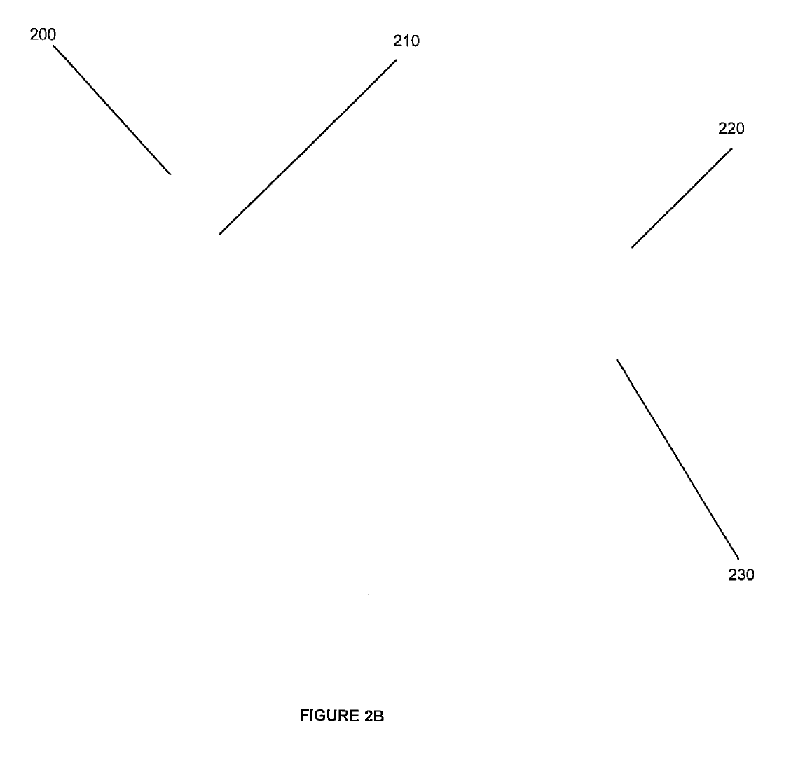

Referring now to FIG. 2A, an exemplary wireless keyboard 200 in accordance with one embodiment of the present invention is shown. The exemplary wireless keyboard 200 includes a plurality of keys 210 similar to adult keyboards but relatively larger in size for ease of use by children. The keys may be more widely spaced for easy operation by young children. Thus, the keys are more suitable for young children. The wireless keyboard 200 may exclude many adult oriented function keys such as “page up”, “page down”, “F1”, “PrtScn”, “Pause”, etc. so as to reduce the complexity involved in using the device. Moreover, the wireless keyboard 200 may exclude some of the standard punctuation keys. For example, the wireless keyboard 200 may exclude “,”, “;”, “:” and other similar punctuation keys again to reduce the overall complexity of the device.

The wireless keyboard 200 may include functional keys such as a music key, or a “hint” key to provide hints to young children to guide them to operate, navigate and/or complete a task. The wireless keyboard 200 may further include arrow keys to navigate up, down, right and/or left. The keyboard 120 does include a complete set of number keys (o thru 9) and a complete set of alphabet (A thru Z). The keyboard 120 may also contain some non-functional or “fun” keys of various sizes and shapes that may merely play fun sounds when pressed. The keyboard 120 also contains a space bar. It is appreciated that the wireless keyboard 200 may also be battery operated or have a line connection.

According to one embodiment of the present invention, the wireless keyboard 200 may be theme-able with an appearance pleasing for a child. For example, the theme for the GUI 145 (FIG. 1) may be a dog, thus the keyboard may be shaped and themed to look like an animal, e.g., a dog, as shown with eyes, ears, a nose, etc.

The wireless keyboard 200 may further include other input devices such as a cursor directing device, e.g., mouse 230, joystick (not shown) and the like. In this exemplary embodiment, the mouse 230 is coupled to the wireless keyboard 200 via a wire or connector. However, it is appreciated that the mouse 230 may be coupled to the wireless keyboard 200 via other wireless means, e.g., radio frequency, infrared, etc. It is further appreciated that the mouse 230 may be wirelessly coupled to the console 110. The mouse may be smaller in size in order to fit in young children's hand. Moreover, in one embodiment, the mouse may have one mouse button for easy operation by young children.

In one embodiment, the wireless keyboard 200 includes a mouse pad 220. In this exemplary embodiment, the mouse pad 220 is detachable and configurable to be coupled to the wireless keyboard 200 on the right or on the left. Thus, both left handed children and right handed children can use the mouse 230 and the mouse pad 220 effectively. In one embodiment, the mouse pad 220 may be theme-able and may match the theme of the keyboard. For example, for a dog theme the mouse pad 220 may be shaped like and resemble a paw. Similarly, the mouse 230 may be theme-able.

Referring now to FIG. 2B, one exemplary keyboard and mouse and mouse pad in accordance with one embodiment of the present invention is shown. As described above, the keyboard 200 includes a plurality of keys 210 that is similar to adult keyboards but relatively larger in size for ease of use by children. Thus, the keys are more suitable for young children. As discussed above, the keyboard 200 may exclude many adult oriented function keys such as “page up” to reduce the complexity involved in using the device. For similar reasons many punctuations keys may be excluded as well. The keyboard 200 may further include a mouse pad 220 and a mouse 230 that are coupled to the keyboard 200.

In this exemplary embodiment, the keyboard 200 is themed with an appearance pleasing for a child. In this exemplary embodiment, the keyboard 200 is themed to appear like a dog with eyes, ears, mouth as a space bar, nose and paws. It is further appreciated that the mouse 230 and the mouse pad 220 may be similarly themed to have a common theme with the keyboard 200. In this exemplary embodiment, the mouse pad 220 is themed to appear like a paw which is coupled to the keyboard 200 that appears like a dog. Thus, not only the keyboard 200, the mouse pad 220 and the mouse 230 are functional to enable user interaction but they are themed to look pleasing and more suitable to young children.

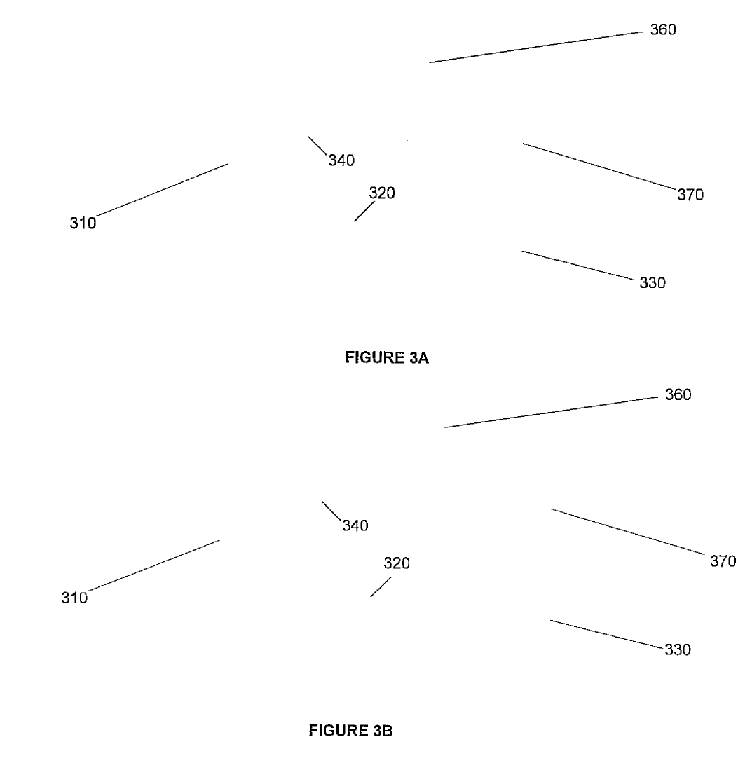

Referring now to FIGS. 3A and 3B, an exemplary graphical user interface in accordance with one embodiment of the present invention is shown. The graphical user interface may be displayed via the display 130 that in one embodiment is a television set. The program generating the graphical user interface resides on the memory component 112 of the console and is executed by the processing unit 114. As shown, the main screen GUI contains an icon for each program that is resident on the console much like general purpose computer systems, a cursor 355 is also displayed and can be used to select the icons to activate the associated programs. In this exemplary embodiment, the GUI has a dog theme with an animated character, e.g., a dog 320 that aids the child in using the GUI and also provides entertainment and instruction.

The animated character 320 in the GUI may provide young children with hints, feedback, instructions, tasks, etc. For example, once the console 110 is turned on, the animated character 320 may introduce itself and instruct the user on how to use the mouse 230 to navigate the cursor through various user selectable programs, e.g., Inbox 310 for emailing, “ABC tree” 340 for the alphabet, “Type Time” 360 for typing, “123 Click” 370 for the number game, etc. Moreover, the animated character 320 may instruct children that to select any of the user selectable programs, they should press the left mouse button of the mouse 230. Furthermore, when the enlarged cursor 355 is moved around and placed over a program icon, the animated character 320 may tell the child what the program does and instruct the child on how to launch the program.

It is appreciated that in one example when the child selects any of the user selectable programs represented as icons within the GUI, e.g., Inbox 310 for email, the animated character 320 may go from the left side of the green to the “Scout's House” 330, which in return launches the selected program. It is further appreciated that the animated character 320 may be animated to make noise, e.g., bark, when something is selected and/or provide feedback, instructions and tasks to children. The GUI may also play background music and sounds that may be related to the child's interaction with the GUI elements.

In this exemplary embodiment, the Inbox 310 program is not connected to the Internet bur rather provides a simulated environment similar to emailing on the Internet. In this example, parents may create canned messages for their children. For example, if the child has selected the Inbox 310 program, once the program is launched a previously written letter from “mom” may be opened saying “I love you.” In other email modes, the child may generate messages for prescribed family members and friends. However, it is appreciated that the Inbox 310 may be coupled to the Internet in other embodiments.

It is appreciated that upon the selection and launching of a program from the GUI, the animated character 320 may be present and interactive within the program itself to provide instructions and to be a focus of rewards earned by the child during game play.

In one example, the animated character 320 gives the child instructions and tasks. For example, when the “ABC tree” 340 is selected, the program launches and may instruct the child to press the letter “A” on the keyboard. If the child presses the wrong key, the animated character 320 may provide feedback and give further instructions to aid the child in pressing the letter “A.” In one embodiment, once the child correctly performs the task, the animated character 320 is rewarded such that the child knows that the task was correctly performed. For example, the animated character 320 may be given a snack or bone. It is appreciated that since the nature of the plurality of user selectable programs is educational, there is generally no concept of a user “dying” or having a given number of “lives.” It is further appreciated that the programs may time-out back to the main screen GUI when there is no interaction for a given period. In one exemplary embodiment, there may be an “end program” icon within each program that allows the user to go back to the main menu. Similarly, the wireless keyboard 200 may timeout and enter a standby mode when the keyboard 200 is not used for a given period of time in order to save battery power.

In one exemplary embodiment, additional educational programs may be added using the removable cartridge 150. Referring now to FIG. 3B, the removable cartridge includes a coloring game 350 that will pop-up along with other user selectable programs as provided by the GUI. Once the removable cartridge 150 is inserted, the child can select between the plurality of user selectable programs as well as one or more programs on the removable cartridge 150.

In one example, the selectable programs include the “ABC tree” 340, “Type time” 360, “123 Click” 370, etc. For example, the “ABC tree” 340 may be an instructional game play on how to recognize alphabet characters. Alphabet letters may be arranged as fruits on a tree and an audio instruction may ask the child to identify a letter using the cursor 355. Similarly, the child may be asked to identify a letter by pressing the correct letter on the keyboard, e.g., “press A”. Other programs like “Type time” 360 may be geared toward learning how to type and the “123 Click” 370 may be geared toward learning about numbers. Similarly other programs may aid young children in improving their mouse and keyboard skills. It is appreciated that the programs are in general reward-based and instructional in nature. Thus, the child is asked to perform a task and in response thereto is provided with feedback and reward. It is further appreciated that the child may interact with the GUI and the program via animated characters provided by the GUI.

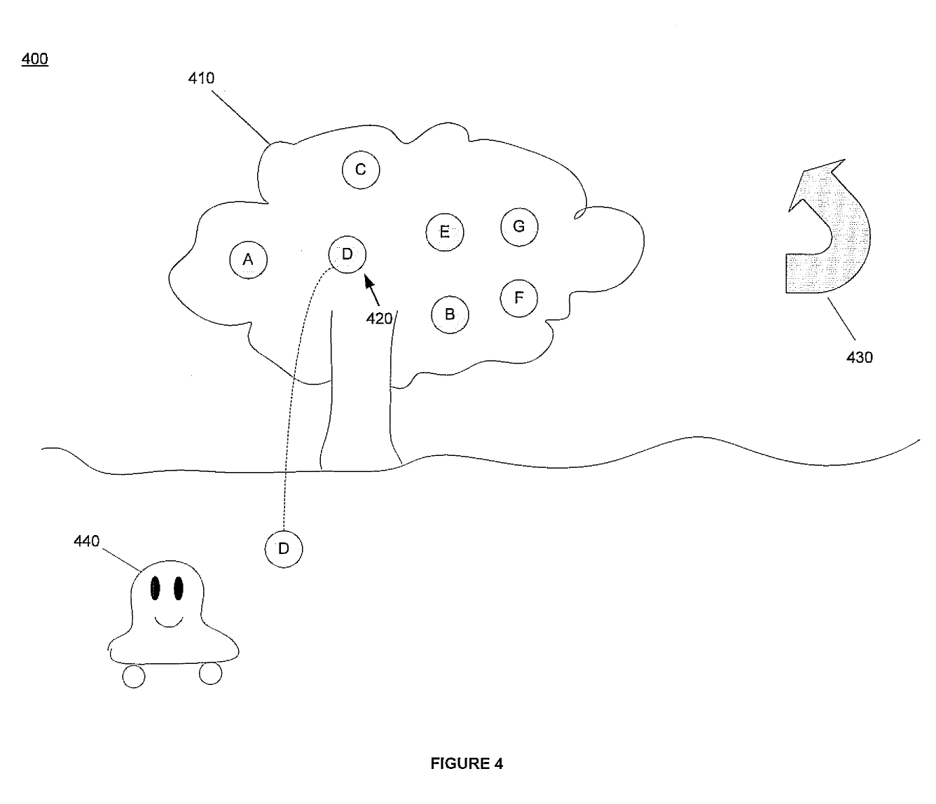

Referring now to FIG. 4, a GUI executing a selectable program in accordance with one embodiment of the present invention is shown. In this example the “ABC tree” 410 program is selected. The “ABC tree” 410 program assist in educating young children about the alphabet, e.g., A, B, C, etc. Young children can interact with the program using the cursor 420 or via the keyboard as previously described. The “ABC tree” 410 contains letters fro the alphabet.

As described above, an animated character 440, e.g., a ghost, may interact with the young child via the GUI. In this example, the animated character 440 may ask the child “which one is the letter D?”. The young child may then use the cursor 420 to navigate and select the letter or can use the keyboard instead. When the child properly selects the letter “D” the animated character 440 may sing a song to notify the child that the answer was correct and as a reward the letter “D” may fall from the “ABC tree” 410 like an apple and picked up by the animated character 440. It is appreciated that the letters on the “ABC tree” 410 may be shaped like various fruits, e.g., apple, orange, etc. When the wrong letter is selected by the child, the animated character 440 may output an audio message to the child notifying that an improper letter was selected. Additionally, the animated character 440 may provide feedback and instructions aiding the child on how to select the proper letter. The animated character 440 may further tell the child to try again.

It is appreciated that the program may be provided with a “Return” to main screen button 430. Thus, when the user selects the “Return” button 430, the program terminates and reverts back to the main GUI screen. It is appreciated that return to the main GUI screen may also take place when the program is inactive for a period of time. Thus, the program may time out and may revert back to the main GUI screen.

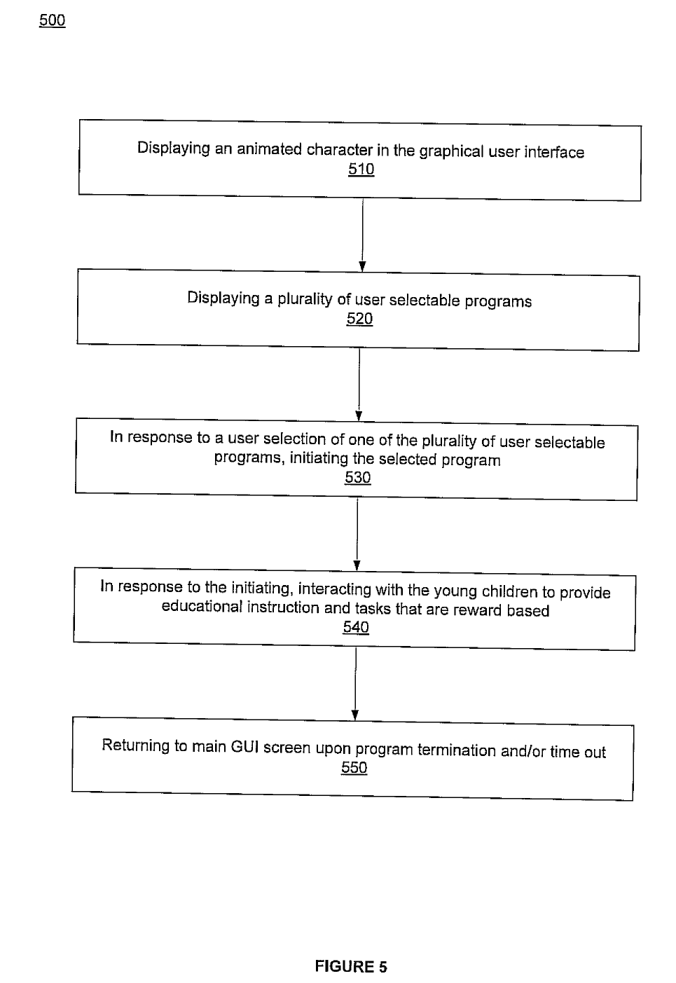

Referring now to FIG. 5, an exemplary flow diagram 500 for providing a computer environment to young children in accordance with one embodiment of the present invention is shown. At step 510, an animated character of a GUI may be provided and displayed on the display 130, e.g., television set. The animated character, e.g., the dog 320, may interact with the child, may give tasks, may provide feedback and aid in navigating the GUI. For example, the animated character 320 may instruct the user what each of the user selectable programs are and how to launch and select a user selectable program. Moreover, the animated character 320 may instruct the user on how to navigate the cursor to make a selection. Furthermore, the animated character 320 may notify the user what each user selectable does and how to launch them as the user moves the cursor around on the GUI.

At step 520, a plurality of user selectable programs are simultaneously displayed with animated character. Each program may be displayed as a large icon. In general, each program is educational in nature and interactive. For example, the plurality of user selectable programs may include “Inbox” 310 for emailing/receiving canned messages, “ABC tree” 340 for the alphabet, the “Dog Typing Time” 360, the “123 Click” 370 a number game, etc.

At step 530, in response to a user selection of one of the plurality of user selectable programs via interaction with the cursor and the program icon, the selected program is initiated and launched. As described above, the programs are generally educational in their reward-based game play and interactive. As described above, the user selectable programs may be programs that are stored on the console 110 and/or stored on the removable cartridge 150. Importantly, the animated character 320 may be present and interactive in the launched program and may be the focus of any reward earned.

At step 540, in response to the initiating, the computer system facilitates interaction between the user, e.g., young child, and the selected program. In general, the programs are reward based where the interaction provides feedback in response to the user input. For example, by performing a task correctly something of value, e.g., a bone or snack, may be given to the animated character, e.g., the dog 320.

Moreover, the animated character 320 may provide instructions and feedback to the user. For example, the animated character 320 may instruct the user to press the letter “A”. In response to the user pressing a key, the animated character 320 provides feedback. For example, if the letter “A” is correctly pressed, the dog may jump, get a bone and run to Scout's House 330. The dog 320 may then sing a song congratulating the user on performing the task correctly.

On the other hand, if the user presses the wrong key, the animated character 320 may provide instructional feedback, tips and hints to aid the user in learning and pressing the correct key. It is appreciated that the feedback may be audio, animation, expression, etc. As described before, the user input may be facilitated via the wireless keyboard 120 and/or input device 140, e.g., mouse 230, joystick, etc.

At step 550, the GUI may return to the main GUI screen upon program termination by the user. It is appreciated that the return to the main GUI screen may also take place when the program is idle for a certain period. As a result, the program times out and returns to the main GUI screen.

As a result, an inexpensive computer environment suitable for young children that simulates a PC experience is provided.

What is claimed is:

1. A computer system comprising:
a console operable to be coupled to a display, said console comprising:
a processor operable to execute instructions; and
a memory component operable to store data and computer executable instructions, wherein said instructions are operable to provide a plurality of user selectable programs, and wherein said plurality of user selectable programs are user interactive and educational, and wherein said plurality of user selectable programs provide feedback in response to user interaction;
a keyboard wirelessly coupled to said console, wherein said keyboard is adapted for use by young children and responsive to user interaction, and wherein said keyboard comprises keys that are larger in size than an adult keyboard, and wherein said keyboard excludes a subset of adult oriented function keys and punctuation keys; and
a mouse input device responsive to user interaction and operable to aid in program navigation of said plurality of user selectable programs.

2. The computer system as described in claim 1, wherein said display is a television set.

3. The computer system as described in claim 1, wherein said keyboard is wirelessly coupled to said console via infrared signal.

4. The computer system as described in claim 1 wherein said keyboard comprises receiving slots operable to receive a mouse pad on the right and left side and further comprising a detachable mouse pad operable to be physically connected to the left or the right side of said keyboard.

5. The computer system as described in claim 4, wherein said mouse pad and said keyboard share a common child oriented theme in appearance.

6. The computer system as described in claim 5, wherein said console further is operable to display a graphical user interface comprising:
icons for said plurality of user selectable programs;
a cursor image; and
an animated character for instructing a user and wherein said animated character shares said common child oriented theme.

7. The computer system as described in claim 1, wherein each of said plurality of user selectable programs include an animated character, and wherein at least one of said plurality of user selectable programs is reward task oriented for tasks completed by a young child, wherein said reward task oriented program provides rewards to said animated character in response to a correctly completed task.

8. The computer system as described in claim 1, wherein said console is operable to receive a cartridge, and wherein said cartridge contains memory storing a plurality of instructions for executing a task to interactively facilitate educational instructions to a user and in response thereto provide audio and visual feedback.

9. A computer system comprising:
a console comprising:
a processor operable to execute instructions; and
a memory component operable to store data and computer executable instructions, wherein said instructions are operable to provide a plurality of user selectable programs that are user interactive and educational in nature, and wherein said plurality of user selectable programs provide feedback in response to user interaction;
a display for displaying a graphical user interface comprising a plurality of icons relating to said plurality of user selectable programs and an animated character operable to aid in program navigation;
a keyboard wirelessly coupled to said console, wherein said keyboard is adapted for use by young children; and
a mouse input device operable to facilitate program navigation, wherein said keyboard and said animated character share a common child oriented theme.

10. The computer system as described in claim 9, wherein said keyboard is wirelessly coupled to said console via infrared signal.

11. The computer system as described in claim 9 further comprising:
a detachable mouse pad operable to be coupled to the left or the right side of said keyboard.

12. The computer system as described in claim 11, wherein said mouse pad shares said common child oriented theme.

13. The computer system as described in claim 9, wherein at least one of said plurality of user selectable programs is reward task oriented for tasks completed by a young child, wherein said reward task oriented program provides a reward to said animated character in response to a correctly completed task.

14. The computer system as described in claim 9, wherein said keyboard comprises keys that are larger in size than an adult oriented keyboard and excludes a subset of adult oriented function keys and punctuation keys.

15. The computer system as described in claim 9, wherein said console is operable to receive a removable cartridge, and wherein said removable cartridge contains memory that stores a plurality of instructions for executing a task to interactively facilitate educational instructions to a user and in response thereto provide audio and visual feedback.

16. A computer implemented method of providing educational interaction to a young child comprising:
displaying within a graphical user interface an animated character operable to provide feedback to said young child and aid in navigating within said graphical user interface;
in said graphical user interface, displaying a plurality of icons representing a plurality of user selectable programs that are child oriented and user interactive and educational;
in response to a user selection of one of said plurality of user selectable programs, initiating said selected program; and
in response to said initiating, interacting with said young child to provide educational instruction and tasks that are reward based, and wherein said interaction provides instructional feedback in response to an input by said young child, and wherein said selected program provides a reward to said animated character in response to a correctly completed task.

17. The method as described in claim 16, wherein said input by said young child is facilitated via a wireless keyboard adapted for use by young children that comprises keys that are larger in size than an adult keyboard, and wherein said wireless keyboard excludes a subset of adult oriented function keys and punctuation keys.

18. The method as described in claim 17, wherein said wireless keyboard and said animated character share a common child oriented theme.

19. The method as described in claim 16, wherein said input by said young child is facilitated via mouse input device operable to aid in said navigating.

20. The method as described in claim 16, wherein at least one of said plurality of user selectable programs is provided via a removable cartridge.

21. The method as described in claim 16, wherein said displaying is via a television set.
